(19) United States
(12) Patent Application Publication
(10) Pub. No.: US 2017/0285975 A1
(43) Pub. Date: Oct. 5, 2017

(54) TECHNOLOGIES FOR MANAGING IMMUTABLE DATA ON A DATA STORAGE DEVICE

(71) Applicants: Sanjeev N. Trika, Portland, OR (US); Kshitij A. Doshi, Chandler, AZ (US)

(72) Inventors: Sanjeev N. Trika, Portland, OR (US); Kshitij A. Doshi, Chandler, AZ (US)

(21) Appl. No.: 15/088,955

(22) Filed: Apr. 1, 2016

(51) Int. Cl. G06F 3/06

(52) U.S. Cl. CPC G06F 3/0619; G06F 3/0659; G06F 3/0673

(57) ABSTRACT

Technologies for managing immutable data include a data storage device having a data storage controller and memory for storing data. The data storage controller may receive requests from a host of the data storage device to mark data stored in the memory as immutable. In response to the request, the data storage controller is configured to set an immutable flag associated with the identified data to mark the identified data as immutable. The immutable flag, when set, provides an indication that the associated data is unmodifiable. In some embodiments, the data storage device may also compact and/or move the immutable data to an immutable memory region of the memory. Technologies to mark the immutable data as mutable, write to the immutable data, and delete or trim the immutable data are also disclosed.

### BACKGROUND

Data storage devices, such as solid state drives, hard disk drives, and memory devices, are capable of storing and providing access to various types of data. Of course, during use, different types of data may be accessed or used more often than other types of data. Depending on the particular storage technology used, differing access frequency of portions of the stored data can result in uneven or otherwise undesirable wear leveling across the data storage device.

The storage capacity of data storage devices is another concern often monitored by the data storage devices or hosts of the devices. To increase storage capacity, some data storage devices may compress or de-duplicate stored data. However, such compression and/or deduplication can result in an increased processor and/or power demand if the associated data is accessed frequently. Additionally, when dynamic storage capacity is used, the host of the data storage device may be required to track multiple pieces of information related to the dynamic storage capacity, such as the reported remaining storage capacity, the total number of data writes allowed until the next storage capacity check, and/or other related information.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a data storage device for managing immutable data;

FIG. 2 is a simplified block diagram of at least one embodiment of an environment that may be established by the data storage device of FIG. 1;

FIG. 3 is a simplified block diagram of at least one embodiment of a method for marking data as immutable that may be executed by the data storage device of FIGS. 1 and 2;

FIG. 4 is a simplified block diagram of at least one embodiment of a method for converting immutable data to mutable data that may be executed by the data storage device of FIGS. 1 and 2;

FIG. 5 is a simplified block diagram of at least one embodiment of a method for writing to immutable data that may be executed by the data storage device of FIGS. 1 and 2;

FIG. 6 is a simplified block diagram of at least one embodiment of a method for deleting/trimming immutable data that may be executed by the data storage device of FIGS. 1 and 2;

FIG. 7 is a simplified block diagram of at least one embodiment of a method for managing mutable data that may be executed by a host in communication with the data storage device of FIGS. 1 and 2; and

FIG. 8 is a simplified block diagram of at least one embodiment of a computing device including the data storage device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

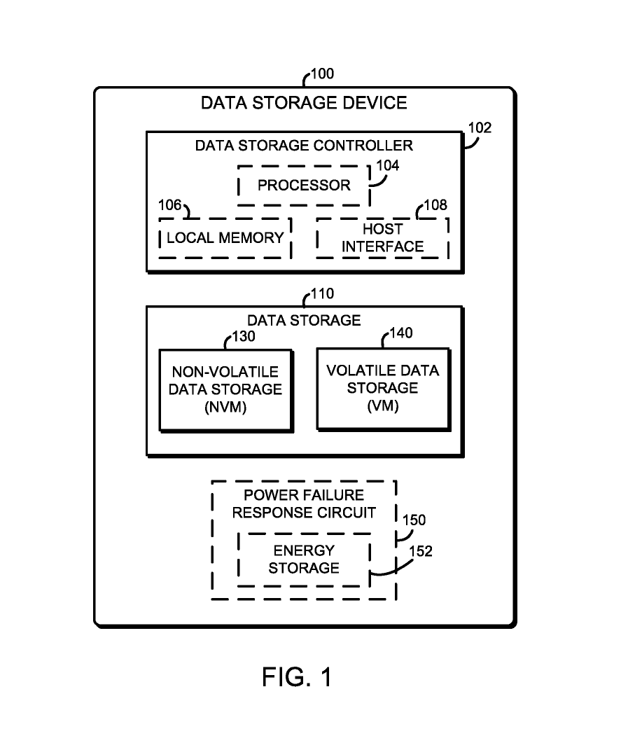

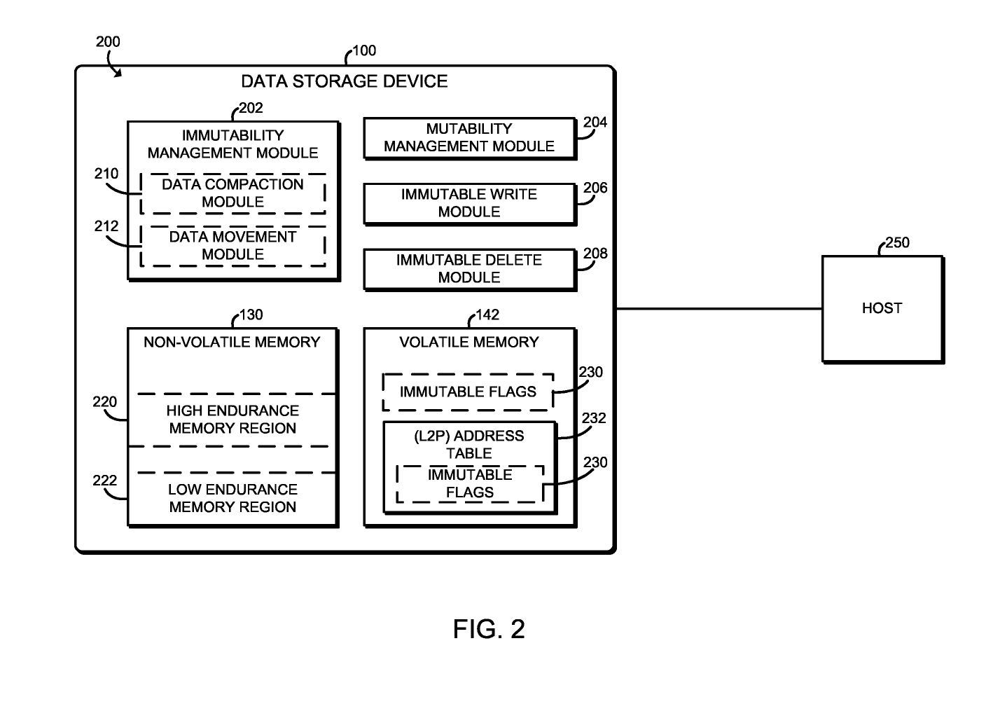

As shown in FIG. 1, an illustrative data storage device 100 for managing immutable data includes a data storage controller 102 and a memory or data storage 110, which illustratively includes non-volatile data storage/memory 130 and volatile data storage/memory 140. As discussed in more detail below, in use, the data storage controller 102 is configured to mark data stored in the data storage 110 as immutable in response to an associated request received from a host 250 (see FIG. 2) of the data storage device 100. To do so, in the illustrative embodiment, the data storage controller 102 sets an immutable flag associated with the data identified in the request to mark the associated data as immutable. Once marked as immutable, the associated data is generally unmodifiable, except for specific write or deletion instructions received from the host 250 as discussed in more detail below. In some embodiments, the data storage controller 102 may also compact (e.g., compress, dedup, etc.) the identified data as part of the immutable marking procedure. By compacting the identified data, the data storage controller 102 may increase the dynamic storage capacity of the data storage 110. Additionally, because the compacted data is marked as immutable (i.e., generally not modifiable), the typical overhead associated with accessing compacted data (i.e., the requirement to uncompact the data to write to the data) is minimized or otherwise reduced.

Additionally, in some embodiments, the data storage controller 102 may move the identified data from a default or mutable memory region of the data storage 110 to an immutable memory region of the data storage 110 as part of the immutable marking procedure. For example, the data storage 110 may move the data from a high endurance memory region of the data storage 110 (e.g., of the non-volatile memory 130) to a relatively low endurance memory region of the data storage 110 (e.g., of the non-volatile memory 130). It should be appreciated that because the immutable data is generally unmodifiable, a low endurance memory region may be used to store the immutable data due to the expected lower number of writes to the immutable data.

The data storage controller 102 is also configured to respond to requests from the host (see FIG. 2) to convert immutable data (i.e., data marked as immutable) to mutable data. To do so, the data storage controller 102 resets the immutable flag associated with the immutable data to indicate that the associated data is now modifiable. Additionally, in embodiments in which the immutable data is compacted, the data storage controller 102 uncompacts the immutable data as part of the converting procedure. Similarly, in embodiments in which the immutable data is moved to the immutable memory region of the data storage 110, the data storage controller 102 may move the immutable data from the immutable memory region (e.g., a low endurance memory region) to a mutable memory region (e.g., a high endurance memory region) of the data storage 110.

As discussed in more detail below, the data storage controller 102 may also respond to other requests from the host 250 (see FIG. 2) associated with the immutable data such as immutable write requests directed to the immutable data and/or deletion or trimming requests directed to the immutable data. To facilitate the requests from the host 250, the data storage controller 102 may expose a suitable application program interface (API) to provide new commands to the host 250 (e.g., a “finalize” command to mark data as immutable, an “unfinalize” command to convert immutable data to mutable data, an “immutable write” command to write to immutable data, and/or an “immutable delete/trim” command to delete or trim immutable data).

The data storage device 100 may be embodied as any type of device capable of storing data and performing the functions described herein. In the illustrative embodiment, the data storage device 100 is embodied as a solid state drive; however, in other embodiments, the data storage device 100 may embodied as a hard disk drive, a memory module device, a cache memory device, and/or other data storage device.

The data storage controller 102 of the data storage device 100 may be embodied as any type of control device, circuitry, or collection of hardware devices capable of managing data stored in the non-volatile memory storage 130. In the illustrative embodiment, the data storage controller 102 includes a processor or processing circuitry 104, local memory 106, and a host interface 108. Of course, the data storage controller 102 may include additional devices, circuits, and/or components commonly found in a drive controller of a solid state drive in other embodiments.

The processor 104 may be embodied as any type of processor capable of performing the functions described herein. For example, the processor 104 may be embodied as a single or multi-core processor(s), digital signal processor, microcontroller, or other processor or processing/controlling circuit. Similarly, the local memory 106 may be embodied as any type of volatile and/or non-volatile memory or data storage capable of performing the functions described herein. In the illustrative embodiment, the local memory 106 stores firmware and/or other instructions executable by the processor 104 to perform the described functions of the data storage controller 102. In some embodiments, the processor 104 and the local memory 106 may form a portion of a System-on-a-Chip (SoC) and be incorporated, along with other components of the data storage controller 102, onto a single integrated circuit chip.

The host interface 108 may also be embodied as any type of hardware processor, processing circuitry, input/output circuitry, and/or collection of components capable of facilitating communication of the data storage device 100 with a host device or service (e.g., a host application). That is, the host interface 108 embodies or establishes an interface for accessing data stored on the data storage device 100 (e.g., stored in the data storage 110). To do so, the host interface 108 may be configured to utilize any suitable communication protocol and/or technology to facilitate communications with the data storage device 100 depending on the type of data storage device. For example, the host interface 108 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology in some embodiments.

The non-volatile data storage 130 may be embodied as any type of data storage capable of storing data in a persistent manner. For example, in the illustrative embodiment, the non-volatile data storage 130 is embodied as non-volatile memory and is referred to hereinafter as non-volatile memory 130 with the understanding that the non-volatile data storage 130 may be embodied as other types of persistent data storage, such as hard disk platters, in other embodiments. The non-volatile memory 130 may be embodied as NAND flash memory, NOR flash memory, phase change memory (PCM), electrically erasable programmable read-only memory (EEPROM), resistive memory, nanowire memory, three-dimensional cross point memory arrays ferro-electric transistor random access memory (FeTRAM), magnetoresistive random access memory (MRAM), spin transfer torque MRAM, and/or other non-volatile memory.

The volatile data storage 140 may be embodied as any type of data storage capable of storing data while the data storage device 100 is in operation. For example, in the illustrative embodiment, the volatile data storage 140 is embodied as volatile memory and is referred to hereinafter as volatile memory 140 with the understanding that the non-volatile data storage 130 may be embodied as other types of non-persistent data storage in other embodiments. The volatile memory 140 may be embodied as dynamic random access memory (DRAM) or other type of volatile memory.

In some embodiments, the data storage device 100 may also include the power fail response circuit 150, which is configured to provide backup power to certain components of the data storage device 100 for a period of time in the event that power to the data storage device 100 is unexpectedly lost or interrupted. To do so, the power fail response circuit 150 includes an energy storage 152, which may be embodied as any type of energy storage device or devices capable of providing power to components of the data storage device 100 for a period of time. In the illustrative embodiment, the energy storage 152 is embodied as a bank of capacitors, which are charged during operation and from which energy can be extracted in the event of a power interruption. In other embodiments, the energy storage 152 may be embodied as, or otherwise include, other types of energy storage devices such as backup batteries.

Referring now to FIG. 2, in use, the data storage device 100 may establish an environment 200. The illustrative environment 200 includes an immutability management module 202, a mutability management module 204, an immutable write module 206, and an immutable delete module 208. Each of the modules and other components of the environment 200 may be embodied as firmware, software, hardware, or a combination thereof. For example the various modules, logic, and other components of the environment 200 may form a portion of, or otherwise be established by, the data storage controller 102 or other hardware components of the data storage device 100. As such, in some embodiments, any one or more of the modules of the environment 200 may be embodied as a circuit or collection of electrical devices (e.g., an immutability management circuit 202, a mutability management circuit 204, an immutable write circuit 206, an immutable delete circuit 208, etc.).

The immutability management module 202 is configured to handle immutability requests received from the host 250, which may be embodied as an application, service, and/or other device. That is, the immutability management module 202 handles requests from the host 250 to mark data stored in the data storage 110 (e.g., stored in the non-volatile memory 130) as immutable data. As discussed in more detail below, such requests may identify the data to be marked as immutable based on a logical block address (LBA) range included in the request, an identification of a data object included in the request, or other identifying data included in the request. Regardless, in response to such a request, the immutability management module 202 is configured to set an immutable flag 230 associated with the data identified in the request to mark the data as immutable. The immutable flag 230 may be embodied as any type of data, such as a data bit, a register, or other data location, capable of providing an indication that the associated data has been marked as immutable (i.e., unmodifiable). For example, in the illustrative embodiment, the immutable flags 230 are maintained in a special data structure or table in the volatile memory 140 as shown in FIG. 2. In such embodiments, each immutable flag 230 may be associated with a particular piece of data or with a range of data locations (e.g., a range of logical block addresses). In other embodiments, the immutable flags 230 may form a portion of a logical-to-physical address table 232, which is maintained in the volatile memory 140. In either case, the associated data structures may be copied to the non-volatile memory 130 periodically or from time-to-time and/or in response to a power-down or power-failure event to maintain accuracy of the immutable flags 230. Alternatively, in some embodiments, the immutable flags 230 may be maintained in a byte-addressable persistent memory such as the non-volatile memory 130. It should be appreciated that the immutable flag 230 may be set to any suitable value or data to indicate the associated data is immutable (e.g., the immutable flag 230 may be set to a logical high or low depending on the particular implementation).

As discussed in more detail below, the identified data to be marked as immutable may also be compacted and/or moved to an immutable memory region of the data storage 110 (i.e., of the non-volatile memory 130) in some embodiments. To do so, the immutability management module 202 may include a data compaction module 210 and a data movement module 212. The data compaction module 210 is configured to compact the identified data. To do so, the data compaction module 210 may utilize any suitable compaction technique or combination of compaction techniques. For example, in some embodiments, the data compaction module 210 is configured to compress the identified data using a suitable compression algorithm or procedure. Additionally or alternatively, the data compaction module 210 may apply a deduplication procedure on the identified data to reduce the size of the identified data by removing duplicative data parts therefrom. Further, in some embodiments, the data compaction module 210 may additionally or alternatively apply a content-aware re-encoding procedure to the identified data to decrease the overall size of the identified data.

The data movement module 212 is configured to move the identified data from a mutable or default memory region of the non-volatile memory 130 to an immutable memory region of the non-volatile memory 130. For example, in some embodiments, the data movement module 212 may move the identified data from a high endurance memory region 220 of the non-volatile memory 130 to a low endurance memory region 222. The high endurance memory region 220 may embodied as regions of the non-volatile memory 130 having a relatively low write-count and/or regions established in the non-volatile memory 130 using a “high” endurance memory mode. Conversely, the low endurance memory region 222 may be embodied as regions of the non-volatile memory 130 having a relatively high write-count and/or regions established in the non-volatile memory 130 using a “low” endurance memory. For example, in an illustrative embodiment, the non-volatile memory 130 may be embodied as a NAND non-volatile memory 130 implanting a hybrid cell mode. In such embodiments, the high endurance memory region 220 may be embodied as a region of the NAND non-volatile memory 130 configured in single level cell (SLC) mode. Additionally, in such embodiments, the low endurance memory region 222 may be embodied as a region of the NAND non-volatile memory 130 configured in a multi-level cell (MLC), a triple level cell (TLC), or a quad level cell (QLC) mode. It should be appreciated that while the SLC mode-enabled high endurance memory region 220 has an improved endurance, the low endurance memory region 222 using MLC, TLC, or QLC mode can store more bits per cell (i.e., 2 bits, 3 bits, and 4 bits, respectively). Additionally, by using a “low” endurance memory mode to store the immutable data, the overall capacity and storage economy of the data storage device 100 may be increased, while the typical disadvantages of such “low” endurance memory modes may be reduced due to the expected low number of writes to the immutable data. It should also be appreciated that the immutability management module 202 may perform each functionality in any order depending on the particular embodiment (e.g., moving the identified data to the immutable memory region prior to compacting the identified data and setting the immutable flag 230, compacting the identified data prior to moving the compacted identified data to the immutable memory region and resetting the immutable flag 230, etc.)

The mutability management module 204 is configured to handle mutability requests received from the host 250. That is, the mutability management module 204 handles requests from the host to covert immutable data (i.e., data that the immutability management module 202 has previously marked as immutable) to mutable data. To do so, the mutability management module 204 may perform the inverse to each of the functions of the immutability management module 202 performed on the data. For example, the mutability management module 204 may reset the immutable flag 230 associated with the data identified in the mutability request to indicate that the immutable data is now mutable (i.e., can now be modified).

Additionally, in embodiments in which the immutable data is compacted, the mutability management module 204 may uncompact (e.g., un-compress, un-deduplicate, etc.) the immutable data. Of course, the non-volatile memory 130 may not have enough available capacity to store the immutable data in an uncompressed state. As such, the mutability management module 204 may first verify the capacity of the non-volatile memory 130 and uncompact the immutable data only if the remaining capacity is sufficient (e.g., greater than a threshold amount). Otherwise, the mutability management module 204 may cause the mutability request to fail. Further, in embodiments in which the immutable data is stored in an immutable region of the non-volatile memory 130, the mutability management module 204 may move the immutable data from the immutable memory region to the mutable or default memory region (e.g., from the low endurance memory region 222 to the high endurance memory region 220). It should be appreciated that mutability management module 204 may perform each functionality in any order depending on the particular embodiment (e.g., moving the immutable data to the mutable memory region prior to uncompacting the immutable data and resetting the immutable flag 230, uncompacting the immutable data prior to moving the uncompact immutable data to the mutable memory region and resetting the immutable flag 230, etc.)

The immutable write module 206 is configured to handle write requests to the data that has been marked as immutable (i.e., unmodifiable). In some embodiments, the immutable write module 206 is configured to block typical write requests, but allow special “immutable write” requests to the immutable data. To do so, the immutable write module 206 may check the immutable flag associated with data identified in the write request and reject any typical write request to immutable-marked data. In this way, the frequency of writing to the immutable data may be reduced.

In response to an immutable write request received from the host 250, the immutable write module 206 is configured to convert the immutable data identified in the immutable write request from immutable data to mutable data. To do so, the immutable write module 206 may employ the functionality of the mutability management module 204 discussed above (e.g., uncompact the immutable data, move the immutable data to the mutable memory region, and/or reset the associated immutable flag 230). After the identified immutable data has been converted to mutable data, the immutable write module 206 may perform the requested write onto the converted mutable data in a typical manner After the mutable data has been written to, the immutable write module 206 converts the mutable data back to immutable data using the functionally of the immutability management module 202 discussed above (e.g., compact the mutable data, move the mutable data to the immutable memory region, and/or set the associated immutable flag 230).

The immutable delete module 208 is configured to handle delete or trim requests to data that has been marked as immutable. To do so, the immutable delete module 208 may perform the delete or trim function on the immutable data in a typical manner However, because the immutable data is compacted in some embodiments, the immutable delete module 208 is configured to determine an updated remaining storage capacity of the data storage 110 (e.g., of the non-volatile memory 130) based on the compacted size of the deleted immutable data and report the updated remaining storage capacity to the host 250. In this way, the host 250 may monitor the dynamic storage capacity of the data storage 110 based on the remaining storage capacity without also monitoring write counts.

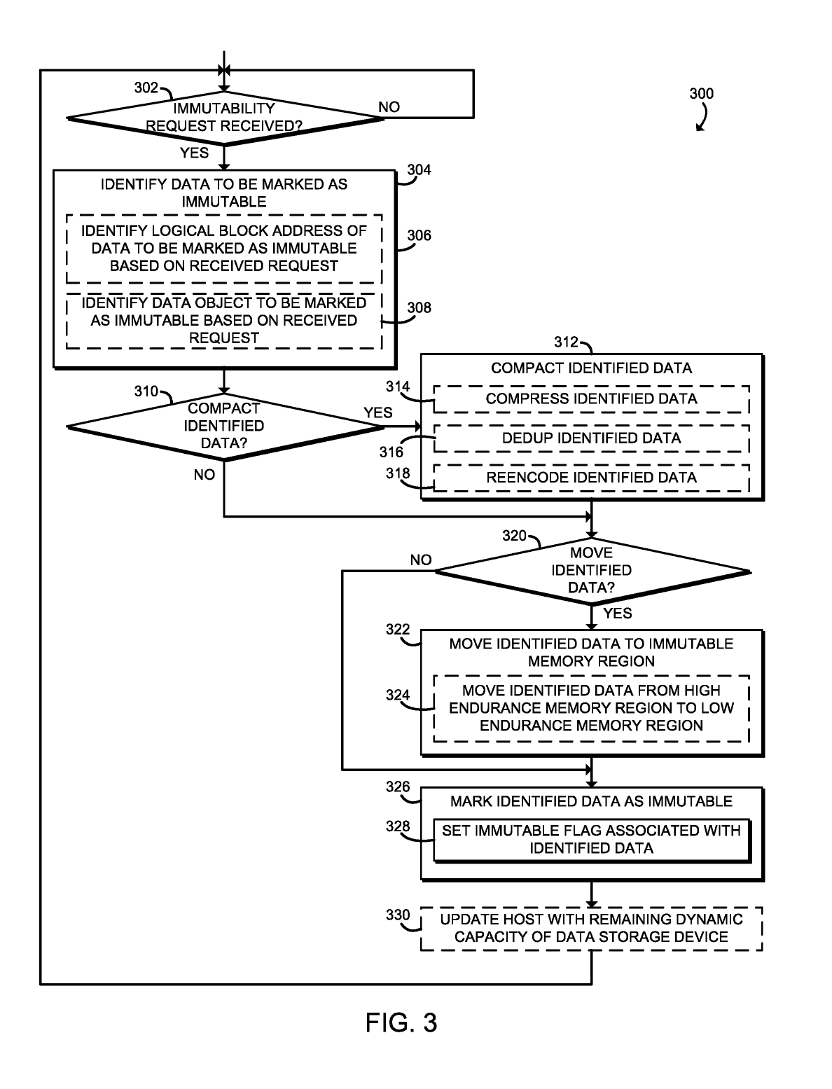

Referring now to FIG. 3, in use, the data storage controller 102 of the data storage device 100 may execute a method 300 for marking data as immutable. The method 300 begins with block 302 in which the data storage controller 102 determines whether an immutability request has been received from the host 250. If so, the method 300 advances to block 304 in which the data storage controller 102 identifies the data to be marked as immutable. In the illustrative embodiment, the request received from the host 250 identifies the data to be marked as immutable. To do so, the request may include any type of identifier capable of identify the data. For example, in some embodiments in block 306, the data storage controller 102 may identify the data to be marked as immutable based on a logical block address (LBA) range included in the request received from the host 250. Alternatively, in block 308, the data storage controller 102 may identify the data to be marked as immutable based on a data object included in the request received from the host 250.

Regardless, after the data storage controller 102 has identified the data to be marked as immutable, the method 300 advances to block 310 in which the data storage controller 102 determines whether the identified data is to be compacted. For example, in some embodiments, the data storage controller 102 may analyze the identified data to determine whether compacting the identified data would yield a storage capacity savings greater than a threshold amount and perform the compaction if so. Alternatively, in other embodiments, all data to be marked as immutable may be compacted. In yet other embodiments, only a portion of the data that has been identified as highly compressible may be compacted.

If the data storage controller 102 determines that the identified data is to be compacted in block 310, the method 300 advances to block 312 in which the data storage controller 102 compacts the identified data. To do so, the data storage controller 102 may use any one or more compaction algorithms and/or technologies to compact the data to reduce the overall size of the data. For example, in block 314, the data storage controller 102 may compress the identified data. Additionally or alternatively, in block 316, the data storage controller 102 may perform a deduplication process on the identified data. Additionally or alternatively, in block 318, the data storage controller 102 may perform a content-aware re-encoding process on the identified data. Of course, in other embodiments, the data storage controller 102 may perform additional or other compaction processes on the identified data.

If the identified data is determined to be compacted in block 310 or after the data is compacted in block 312, the method 300 advances to block 320. In block 320, the data storage controller 102 determines whether the identified data is to be moved to an immutable memory region of the non-volatile memory 130. In some embodiments, as discussed above, a region of the non-volatile memory 130 may be dedicated to storing immutable data. The immutable memory region may be, for example, a memory region having a lower write endurance than other regions of the non-volatile memory 130. In other embodiments, the non-volatile memory 130 may not include any particular region for storing the immutable data and, in such embodiments, the immutable data may not be moved within the non-volatile memory 130. If, however, the data storage controller 102 determines that the identified data is to be moved in block 320, the method 300 advances to block 322 in which the data storage controller 102 moves the identified data from its default location (e.g., a mutable memory region) to an immutable memory region of the non-volatile memory 130. For example, in block 324, the data storage controller 102 may move the identified data from a high endurance memory region (e.g., a memory region having a low write count or configured for SLC mode) to a relatively low endurance memory region (e.g., a memory region having a high write count or configured for MLC, TLC, or QLC mode).

After the identified data has been moved in block 322 or if the data storage controller 102 determines that the identified data is not to be moved in block 320, the method 300 advances to block 326. In block 326, the data storage controller 102 marks the identified data as immutable. To do so, in the illustrative embodiment, the data storage controller 102 sets an immutable flag 230 associated with the identified data in block 328. As discussed above, the immutable flag 230 may be embodied as any type of data, such as a data bit, a register, or other data location, capable of providing an indication that the associated data has been marked as immutable (i.e., unmodifiable). For example, in some embodiments, as shown in FIG. 2, the immutable flag 230 may form a portion of a logical-to-physical address table 232.

It should be appreciated that the compaction of the identified data in block 312, the movement of the identified data in block 322, and the marking of the identified data in block 326 may be performed in any sequential order or substantially in parallel with each other in other embodiments. For example, in some embodiments, the identified data may be moved to the immutable memory region prior to being compacted and marked.

Regardless, after the identified data has been compacted, moved, and marked, the method 300 advances to block 330 in some embodiments. In block 330, the data storage controller 102 may update the host 250 with the remaining dynamic storage capacity of the data storage 110. That is, after the identified data has been compacted, moved, and/or flagged as immutable, the data storage controller 102 may determine the remaining storage capacity of the data storage 110 (e.g., of the non-volatile memory 130) and report the remaining storage capacity to the host 250. However, because the immutable data is unmodifiable in the traditional sense, the host 250 need not periodically query the data storage device 100 after a predefined number of writes for updates to the storage capacity because the likelihood of writing over compacted data with un-compacted data is less likely. After the remaining dynamic capacity of the data storage device 100 has been reported to the host 250, the method 300 loops back to block 302 in which the data storage device 100 continues to monitor for immutability requests from the host 250.

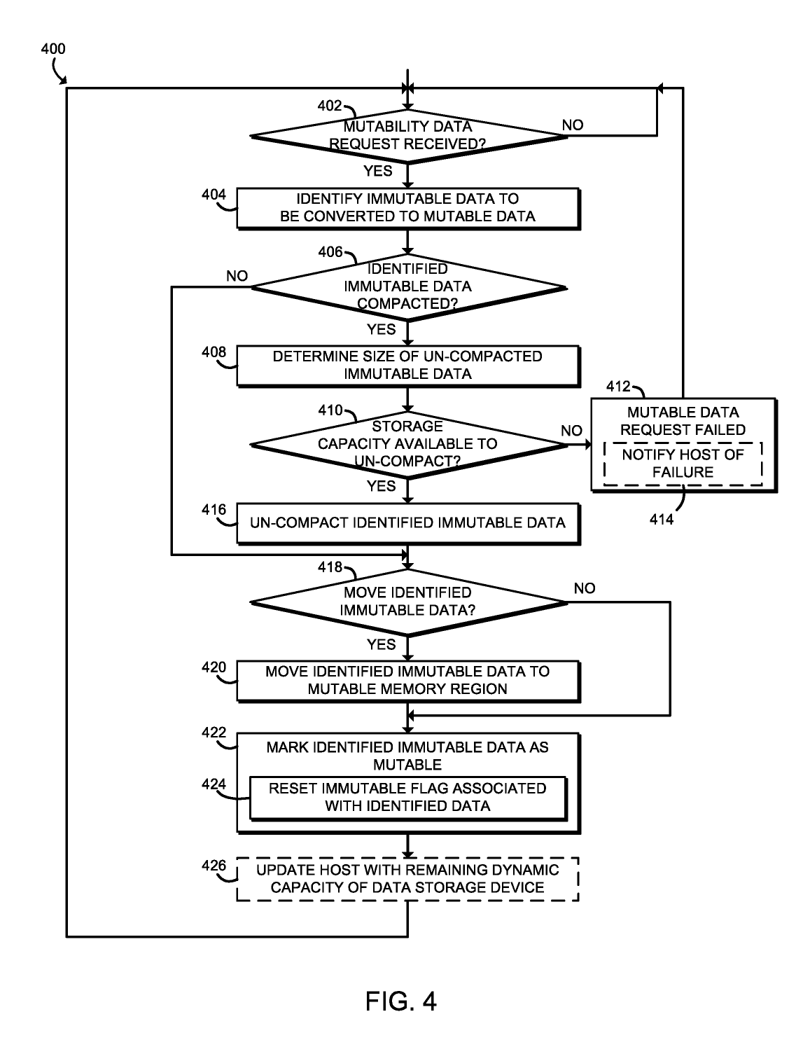

Referring now to FIG. 4, in use, the data storage controller 102 of the data storage device 100 may execute a method 400 for converting immutable data to mutable data. The method 400 begins with block 402 in which the data storage controller 102 determines whether a mutability request has been received from the host 250. If so, the method 400 advances to block 404 in which the data storage controller 102 identifies the immutable data to be converted to mutable data. As discussed above in regard to FIG. 3, the request received from the host 250 may identify the immutable data by, for example, a logical block address range included in the request or a data object included in the request.

After the data storage controller 102 has identified the immutable data to be converted, the method 400 advances to block 406 in which the data storage controller 102 determines whether the identified immutable data is compacted. To do so, the data storage controller 102 may analyze the immutable data, check an associated compaction flag, or assume compaction based on the associated immutable marking process (e.g., as shown in FIG. 3). If the data storage controller 102 determines that the identified immutable data is compacted, the method 400 advances to block 408 in which the data storage controller 102 determines the size of the un-compacted immutable data. That is, the data storage controller 102 determines the size of memory storage required to store the immutable data in its un-compacted state. Subsequently, in block 410, the data storage controller 102 compares the determined size of the un-compacted immutable data to the remaining available storage capacity of the data storage 110 (e.g., the non-volatile memory 130). If the data storage controller 102 determines that the data storage 110 does not have enough capacity to store the immutable data in its un-compacted state in block 410, the method 400 advances to block 412 in which the data storage controller 102 allows the mutable data request to fail (i.e., the data storage controller 102 does not uncompact the immutable data). Additionally, in some embodiments, the data storage controller 102 may notify the host of the failure of the mutable data request in block 414. The method 400 subsequently loops back to block 402 in which the data storage controller 102 monitors for additional mutable data requests from the host 250.

Referring back to block 410, if the data storage controller 102 determines that the data storage 110 does have enough capacity to store the immutable data in its un-compacted state, the method 400 advances to block 416 in which the data storage controller 102 un-compacts the compacted immutable data. To do so, the data storage controller 102 may use any one or more compaction/un-compaction algorithms and/or technologies to un-compact the immutable data depending on how the immutable data was compacted. For example, the data storage controller 102 may decompress the immutable data, apply a reverse de-duplication process of the immutable data, re-encode the immutable data, and/or perform additional or other un-compaction processors on the immutable data.

After the immutable data has been un-compacted in block 416 or if the data storage controller 102 determines that the immutable data is not compacted in block 406, the method 400 advances to block 418. In block 418, the data storage device determines whether the immutable data is to be moved to a default or mutable memory region of the non-volatile memory 130. If so, the data storage controller 102 moves the identified immutable data from the immutable memory region to the mutable memory region in block 420. For example, in some embodiments, the data storage controller 102 may move the identified immutable data from a relatively low endurance memory region (e.g., a memory region having a high write count or configured for MLC, TLC, or QLC mode) to a relatively high endurance memory region (e.g., a memory region having a low write count or configured for SLC mode).

After the identified immutable data has been moved in block 420 or if the data storage controller 102 determines that the identified immutable data is not to be moved in block 418, the method 400 advances to block 422. In block 422, the data storage controller 102 marks the identified immutable data as mutable (i.e., modifiable). To do so, in the illustrative embodiment, the data storage controller 102 resets the immutable flag 230 associated with the identified immutable data in block 424. Again, as discussed above, the immutable flag 230 may be embodied as any type of data, such as a data bit, a register, or other data location, capable of providing an indication that the associated data has been marked as immutable (i.e., unmodifiable).

As discussed above with regard to FIG. 3, it should be appreciated that the un-compaction of the identified immutable data in block 416, the movement of the identified immutable data in block 420, and the marking of the identified immutable data as mutable data in block 422 may be performed in any sequential order or substantially in parallel with each other in other embodiments. For example, in some embodiments, the identified immutable data may be moved to the mutable memory region prior to being un-compacted and marked as mutable.

Regardless, after the identified mutable data has been un-compacted, moved, and appropriately marked, the method 400 advances to block 426 in some embodiments. In block 426, the data storage controller 102 may update the host 250 with the remaining dynamic storage capacity of the data storage 110. That is, after the identified immutable data has been un-compacted, moved, and/or flagged as mutable, the data storage controller 102 may determine the remaining storage capacity of the data storage 110 (e.g., of the non-volatile memory 130) and report the remaining storage capacity to the host 250. The method 400 subsequently loops back to block 402 in which the data storage device 100 continues to monitor for mutability requests from the host 250.

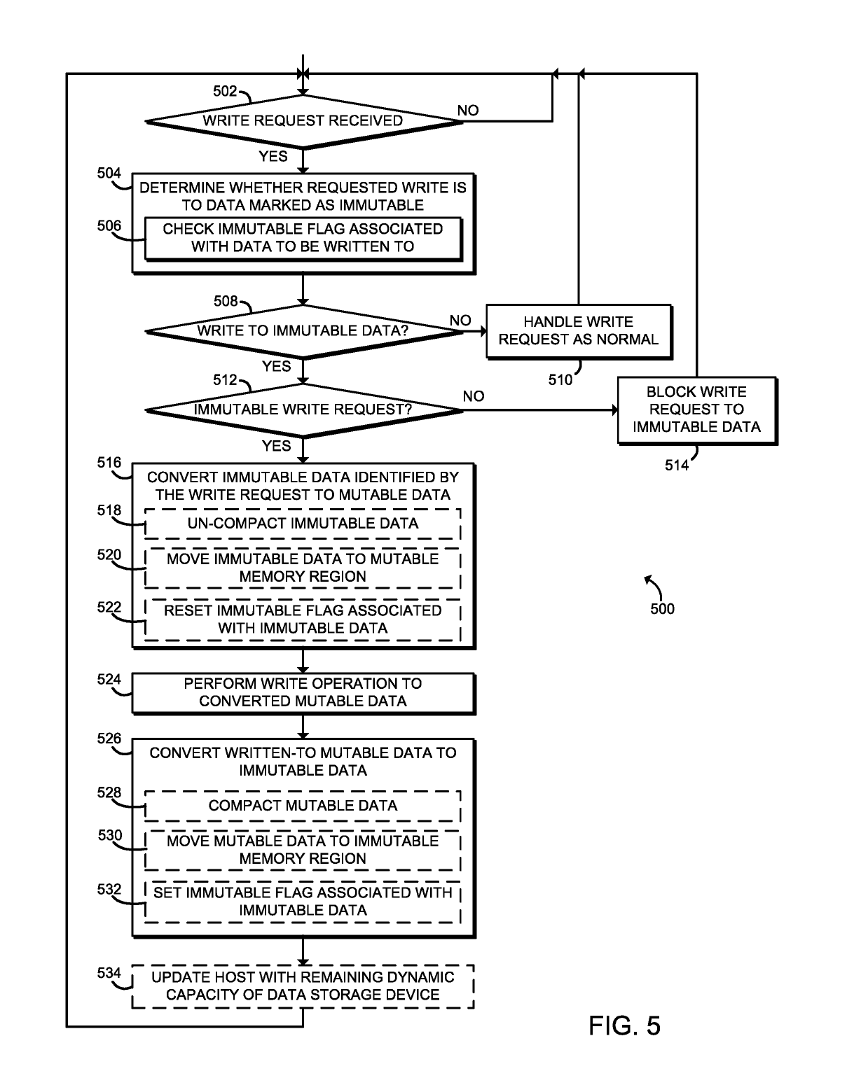

Referring now to FIG. 5, in use, the data storage controller 102 of the data storage device 100 may execute a method 500 for writing to immutable data. The method 500 begins with block 502 in which the data storage controller 102 determines whether a write request has been received from the host 250. If so, the method 500 advances to block 504 in which the data storage controller 102 determines whether the requested write is to data that has been marked as immutable. For example, in the illustrative embodiment, the data storage controller 102 checks the immutable flag 230 associated with the data to be written to in block 506. Alternatively, in other embodiments, the data storage controller 102 may determine whether the data to be written is immutable data based on the location of the data (e.g., the destination location of the write request).

If, in block 508, the data storage controller 102 determines that the requested write is not to immutable data, the method 500 advances to block 510 in which the requested write is handled as normal (i.e., the requested write is to mutable data). The method 500 subsequently loops back to block 502 in which the data storage controller 102 continues to monitor for write requests from the host 250. If, however, the data storage controller 102 determines that the requested write is to immutable data in block 508, the method 500 advances to block 512. In block 512, the data storage controller 102 determines whether the requested write is an immutable write request. That is, the data storage controller 102 determines whether the received write request is a normal write request or a special “immutable write request” usable by the host 250 to write to immutable data. If the data storage controller 102 determines that the write request is not an immutable write request, the method 500 advances to block 514 in which the data storage controller 102 blocks the write request to the immutable data. In this way, typical writes to immutable data are blocked by the data storage controller 102 and the immutable data is maintained as substantially unmodifiable (except for the special immutable write request). The method 500 subsequently loops back to block 502 in which the data storage controller 102 continues to monitor for write requests from the host 250.

Referring back to block 512, if the data storage controller 102 determines that the write request is an immutable write request, the method 500 advances to block 516. In block 516, the data storage controller 102 converts the immutable data identified by the write request to mutable data. Depending on the particular procedures used to mark data as immutable (see FIG. 3), the data storage controller 102 may perform one or more procedures on the immutable data to convert the immutable data to mutable data. For example, in the illustrative embodiment, the data storage controller 102 may un-compact the immutable data in block 518, move the immutable data from an immutable memory region (e.g., a low endurance memory region) to a default or mutable memory region (e.g., a high endurance memory region) in block 520, and/or reset an immutable flag 230 associated with the immutable data in block 522. It should be appreciated that, in some embodiments, the data storage controller 102 may be configured to confirm the storage capacity of the data storage 110 is sufficient prior to un-compacting the immutable data and, if not, failing the write request in a manner similar to the above discussion of blocks 408-414 of method 400 of FIG. 4.

After the data storage controller 102 has converted the identified immutable data to mutable data in block 516, the data storage controller 102 performs the requested write operation on the mutable data in block 524. Because the identified data is now mutable data, the data storage controller 102 may perform the write request in a normal manner.

After the data storage controller 102 has performed the write request on the mutable data, the method 500 advances to block 526 in which the data storage controller 102 converts the written-to mutable data back to immutable data. Again, depending on the particular procedures used to mark data as immutable (see FIG. 3), the data storage controller 102 may perform one or more procedures on the mutable data to convert the mutable data to immutable data. For example, in the illustrative embodiment, the data storage controller 102 may compact the mutable data in block 528, move the mutable data from the default or mutable memory region (e.g., a high endurance memory region) to the immutable memory region (e.g., a low endurance memory region) in block 530, and/or set the immutable flag 230 associated with the mutable data in block 532. In some embodiments, the data storage controller 102 may delay the compacting, moving, and/or marking procedures by a configurable amount of time to reduce the frequency of conversion between compacted and non-compacted data. Additionally, in some embodiments, the data storage controller 102 may update the host 250 with the remaining dynamic storage capacity of the data storage 110 in block 534. The method 500 subsequently loops back to block 502 in which the data storage device 100 continues to monitor for write requests from the host 250.

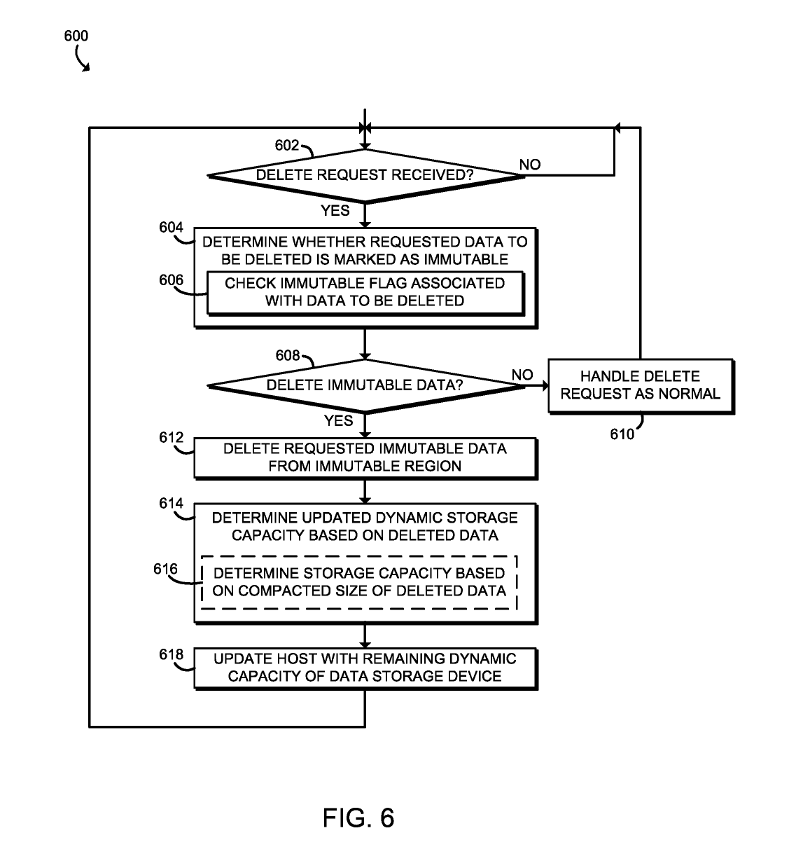

Referring now to FIG. 6, in use, the data storage controller 102 of the data storage device 100 may execute a method 600 for deleting or trimming immutable data. The method 600 begins with block 602 in which the data storage controller 102 determines whether a delete request has been received from the host 250. If so, the method 600 advances to block 604 in which the data storage controller 102 determines whether the requested data to be deleted is marked as immutable. For example, in the illustrative embodiment, the data storage controller 102 checks the immutable flag 230 associated with the data to be deleted in block 606. Alternatively, in other embodiments, the data storage controller 102 may determine whether the data to be deleted is immutable data based on the location of the data.

If, in block 608, the data storage controller 102 determines that the requested data to be deleted is not immutable data, the method 600 advances to block 610 in which the requested deletion is handled as normal (i.e., the requested deletion is for mutable data). The method 600 subsequently loops back to block 602 in which the data storage controller 102 continues to monitor for delete requests from the host 250. If, however, the data storage controller 102 determines that the requested data to be deleted is immutable data in block 608, the method 600 advances to block 612. In block 612, the data storage controller 102 deletes the requested immutable data from the immutable memory region of the non-volatile memory 130. Depending on the particular memory technology used in the non-volatile memory 130, the deletion process may be performed as a deletion or a trimming process.

In block 614, the data storage controller 102 determines an updated remaining dynamic storage capacity of the data storage 110 (e.g., the non-volatile memory 130) based on the deleted immutable data. For example, in block 616, the data storage controller 102 may determine the updated dynamic storage capacity of the data storage 110 based on the compacted size of the deleted immutable data (rather than on the un-compacted size). Subsequently, in block 618, the data storage controller 102 updates the host 250 with the remaining dynamic storage capacity of the data storage 110. The method 600 subsequently loops back to block 602 in which the data storage device 100 continues to monitor for delete requests from the host 250.

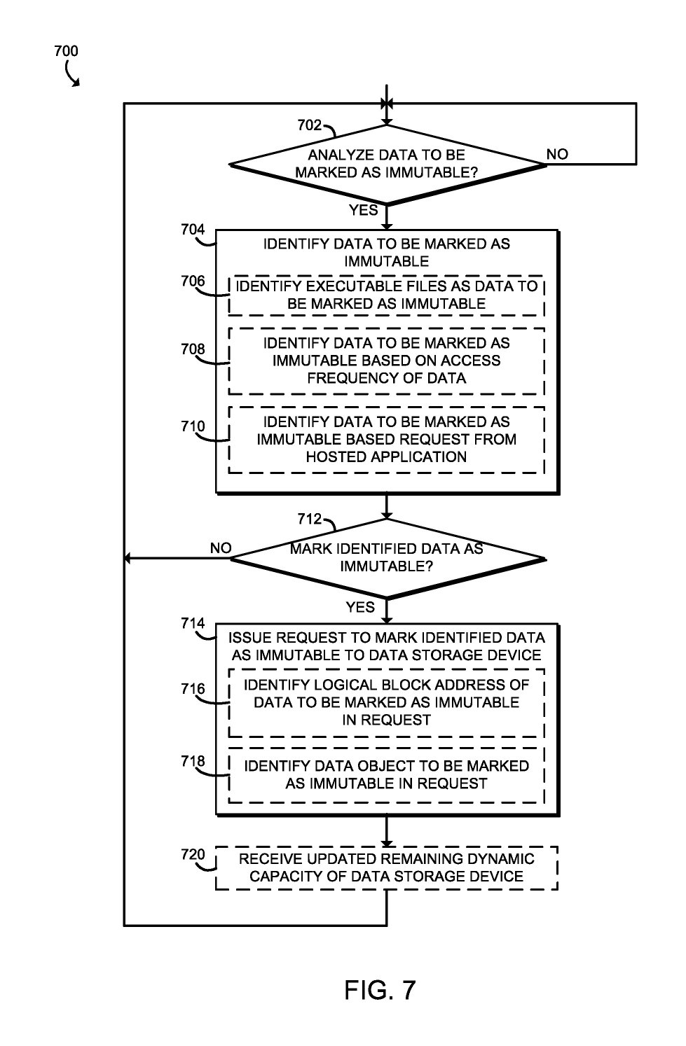

Referring now to FIG. 7, in use, the host 250 (see FIG. 2) may execute a method 700 for managing mutable data. The method 700 begins with block 702 in which the host 250 determines whether to analyze data stored in the data storage device 100, or data that is to be stored in the data storage device 100, to identify data that may be marked as immutable. For example, the host 250 may periodically or responsively analyze the data stored in the data storage device 100.

Regardless, if the host 250 determines to analyze the data, the method 700 advances to block 704. In block 704, the host identifies data to be marked as immutable (i.e., unmodifiable). That is, the host 250 identifies data stored in the data storage device 100 that is unlikely to be changed, written to, or deleted over a period of time. To do so, the host 250 may utilize any methodology to identity candidate data to be marked as immutable. For example, in some embodiments in block 706, the host 250 may identify executable file, which are typically not modified over time, as data to be marked as immutable. Additionally or alternatively, in block 708, the host 250 may identify data to be marked as immutable based on an access or modification frequency of the data. For example, the host 250 may identify data to be marked as immutable as any data that has not been written to for some threshold period of time. Additionally or alternatively, in block 710, one or more applications of the host 250 may assert that particular data is to be stored as immutable data. That is, the host 250 may provide an application program interface to the hosted application to allow the hosted application to self-identify any data as immutable data.

After the host 250 has identified that data to be marked as immutable in block 704, the method 700 advances to block 712 in which the host determines whether to proceed with the immutable marking of the data. If so, the method 700 advances to block 714 in which the host issues a request to the data storage device 100 to mark the identified data as immutable. As discussed above, such requests may identify the data to be marked in various ways. For example, in block 716, the host 250 may issue a request that identifies a logical block address or range of the data to be marked as immutable. Additionally or alternatively, in block 718, the host 250 may issue a request that identifies a data object of the data to be marked as immutable.

After the host 250 issues the request to mark the identified data as immutable in block 714, the method 700 advances to block 720 in some embodiments. In block 720, the host 250 receives an updated remaining dynamic capacity of the data storage 110 from the data storage device 100. As discussed above, because the immutable data is compacted and unlikely to be modified, the host 250 is not required to monitor the write requests to the data storage device 100 and periodically query the data storage device 100, based on the monitored write requests, for updated dynamic storage capacity. The method 700 subsequently loops back to block 702 in which the host 250 again determines whether to analyze data stored in the data storage device 100, or data that is to be stored in the data storage device 100, to identify data that may be marked as immutable.

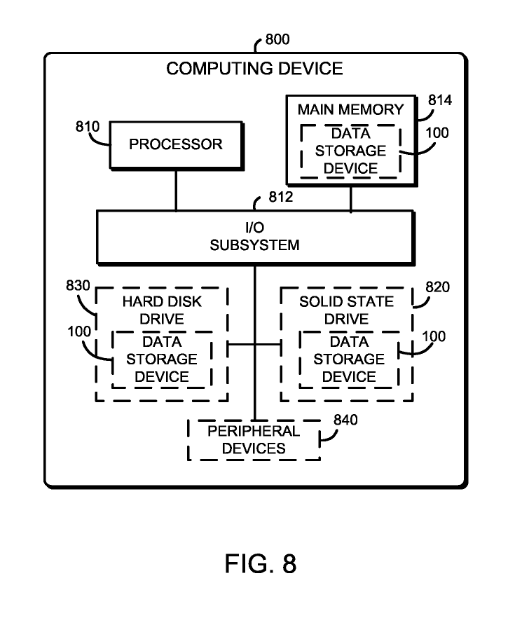

Referring now to FIG. 8, in some embodiments, the data storage device 100 may be incorporated in, or form a portion of, a computing device 800. The computing device 800 may be embodied as any type of computing device in which the data storage device 100 may be used. For example, the computing device 800 may be embodied as a smart phone, a tablet computer, a notebook, a laptop computer, a netbook, an Ultrabook™, a wearable computing device, a pair of smart glasses, a head-mounted computing device, a cellular phone, a desktop computer, a smart device, a personal digital assistant, a mobile Internet device, a server, a data storage device, and/or any other computing/communication device. As shown in FIG. 8, the illustrative computing device 800 includes a processor 810, an input/output (“I/O”) subsystem 812, and a main memory 814. Of course, the computing device 800 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 814, or portions thereof, may be incorporated in the processor 810 in some embodiments.

The processor 810 may be embodied as any type of processor capable of performing the functions described herein. For example, the processor 810 may be embodied as a single or multi-core processor(s), digital signal processor, microcontroller, or other processor or processing/controlling circuit. Similarly, the memory 814 may be embodied as any type of volatile or non-volatile memory or data storage capable of performing the functions described herein. In operation, the memory 814 may store various data and software used during operation of the computing device 800 such as operating systems, applications, programs, libraries, and drivers. The memory 814 is communicatively coupled to the processor 810 via the I/O subsystem 812, which may be embodied as circuitry and/or components to facilitate input/output operations with the processor 810, the memory 814, and other components of the computing device 800. For example, the I/O subsystem 812 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

As shown in FIG. 8, the data storage device 100 may be incorporated in, or form a portion of, one or more other components of the computing device 800. For example, the data storage device 100 may be embodied as, or otherwise be included in, the main memory 814. Additionally or alternatively, the data storage device 100 may be embodied as, or otherwise included in, a solid state drive 820 of the computing device 800. Further, in some embodiments, the data storage device 100 may be embodied as, or otherwise included in, a hard disk drive 830 of the computing device 800. Of course, in other embodiments, the data storage device 100 may be included in or form a portion of other components of the computing device 800.

Reference to memory devices can apply to different memory types, and in particular, any memory that has a bank group architecture. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR4 (DDR version 4, initial specification published in September 2012 by JEDEC), DDR4E (in development by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

In addition to, or alternatively to, volatile memory, in one embodiment, reference to memory devices can refer to a nonvolatile memory device whose state is determinate even if power is interrupted to the device, for such devices that have a bank group architecture. In one embodiment, the nonvolatile memory device is a block addressable memory device, such as NAND or NOR technologies. Thus, a memory device can also include a future generation nonvolatile devices, such as a three dimensional crosspoint memory device, or other byte addressable nonvolatile memory device. In one embodiment, the memory device can be or include multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

### EXAMPLES

Example 1 includes an apparatus comprising a non-volatile memory to store data therein; and a data storage controller to manage read/write access to the memory, wherein the data storage controller is to receive, from a host, a request to mark data identified by the request and stored in the memory as immutable; set, in response to the request to mark the identified data as immutable, an immutable flag associated with the identified data to mark the identified data as immutable data, wherein the immutable flag, when set, indicates that the associated immutable data is unmodifiable.

Example 2 includes the subject matter of Example 1, and wherein the data storage controller is further to block write requests to the immutable data in response to the immutable flag associated with the immutable data being set.

Example 3 includes the subject matter of any of Examples 1 and 2, and wherein the data storage controller is further to compact, in response to the request to mark the identified data as immutable, the identified data.

Example 4 includes the subject matter of any of Examples 1-3, and wherein to compact the identified data comprises to compress the identified data.

Example 5 includes the subject matter of any of Examples 1-4, and wherein to compact the identified data comprises to perform a deduplication process on the identified data.

Example 6 includes the subject matter of any of Examples 1-5, and wherein the data storage controller is further to perform a re-encoding process on the identified data.

Example 7 includes the subject matter of any of Examples 1-6, and wherein the data storage controller is further to move, in response to the request to mark the identified data as immutable, the identified data to an immutable memory region of the memory.

Example 8 includes the subject matter of any of Examples 1-7, and wherein to move the identified data comprises to move the identified data from an original memory region of the memory to a new memory region of the memory having a lower endurance or lower write-performance than the original memory region of the memory.

Example 9 includes the subject matter of any of Examples 1-8, and wherein the data storage controller is further to compact, in response to the request to mark the identified data as immutable, the identified data; and move the compacted identified data from an original memory region of the memory to a new memory region of the memory having a lower endurance or lower write-performance than the original memory region of the memory

Example 10 includes the subject matter of any of Examples 1-9, and wherein the data storage controller is further to determine, after the immutable flag associated with the identified data is set, a remaining storage capacity of the memory; and update the host with the determined remaining storage capacity.

Example 11 includes the subject matter of any of Examples 1-10, and wherein to receive the request to mark the identified data as immutable comprises to receive, from the host, a request that identifies a logical block address range of data stored in the memory that is to be marked as immutable.

Example 12 includes the subject matter of any of Examples 1-11, and wherein to receive the request to mark the identified data as immutable comprises to receive, from the host, a request that identifies a data object of data stored in the memory that is to be marked as immutable.

Example 13 includes the subject matter of any of Examples 1-12, and wherein to set the immutable flag associated with the identified data comprises to set an immutable flag of a logical-to-physical table stored in a volatile memory associated with the memory.

Example 14 includes the subject matter of any of Examples 1-13, and wherein the data storage controller is further to receive, from the host, a request to mark the immutable data as mutable; and reset, in response to the request to mark the immutable data as mutable, the immutable flag associated with the immutable data, wherein the immutable flag, when reset, indicates that the associated immutable data is modifiable.

Example 15 includes the subject matter of any of Examples 1-14, and wherein the data storage controller is further to determine, in response to the request to mark the immutable data as mutable, whether the immutable data is compacted; determine, in response to a determination that the immutable data is compacted, whether the memory has a sufficient remaining storage capacity to store the immutable data in an un-compacted state; and uncompact, in response to a determination that the memory has a sufficient remaining storage capacity, the compacted immutable data.

Example 16 includes the subject matter of any of Examples 1-15, and wherein the data storage controller is further to move, in response to the request to mark the immutable data as mutable, the immutable data to a mutable memory region of the memory.

Example 17 includes the subject matter of any of Examples 1-16, and wherein to move the immutable data to the mutable memory region comprises to move the immutable data from an original memory region of the memory to a new memory region of the memory having a higher endurance than the original memory region of the memory.

Example 18 includes the subject matter of any of Examples 1-17, and wherein the data storage controller is further to unblock write requests to the immutable data in response to the immutable flag associated with the immutable data being reset.

Example 19 includes the subject matter of any of Examples 1-18, and wherein the data storage controller is further to determine, after the immutable flag associated with the immutable data is reset, a remaining storage capacity of the memory; and update the host with the determined remaining storage capacity.

Example 20 includes the subject matter of any of Examples 1-19, and wherein the data storage controller is further to receive, from the host, a write request to write to the immutable data; convert, in response to the write request, the immutable data to mutable data; perform the write request on the converted mutable data; and convert, in response to performance of the write request, the mutable data to immutable data.

Example 21 includes the subject matter of any of Examples 1-20, and wherein to convert the immutable data to mutable data comprises to reset, in response to the write request, the immutable flag associated with the immutable data, wherein the immutable flag, when reset, indicates that the associated immutable data is modifiable.

Example 22 includes the subject matter of any of Examples 1-21, and wherein to convert the immutable data to mutable data comprises to uncompact the immutable data in response to a determination that the memory has a sufficient storage capacity to store the un-compacted immutable data.

Example 23 includes the subject matter of any of Examples 1-22, and wherein to convert the mutable data to immutable data comprises to compact the mutable data.

Example 24 includes the subject matter of any of Examples 1-23, and wherein to convert the immutable data to mutable data comprises to move the immutable data from an original memory region of the memory to a new memory region of the memory having a higher endurance or higher write performance than the original memory region of the memory.

Example 25 includes the subject matter of any of Examples 1-24, and wherein to convert the mutable data to immutable data comprises to move the mutable data from the new memory region to the original memory region.

Example 26 includes the subject matter of any of Examples 1-25, and wherein to convert the mutable data to immutable data comprises to set, in response to performance of the write request, the immutable flag.

Example 27 includes the subject matter of any of Examples 1-26, and wherein the data storage device is further to receive, from the host, a delete request to delete the immutable data; trim, in response to the delete request, immutable data; and determine, after the immutable data is trimmed, a remaining storage capacity of the memory; and update the host with the determined remaining storage capacity.

Example 28 includes a method comprising receiving, from a host and by a data storage controller of an apparatus, a request to mark data identified by the request and stored in a memory of the apparatus as immutable; and setting, by the data storage controller and in response to the request to mark the identified data as immutable, an immutable flag associated with the identified data to mark the identified data as immutable data, wherein the immutable flag, when set, indicates that the associated immutable data is unmodifiable.

Example 29 includes the subject matter of Example 28, and further including blocking, by the data storage controller, write requests to the immutable data in response to the immutable flag associated with the immutable data being set.

Example 30 includes the subject matter of any of Examples 28 and 29, and wherein further comprising compacting, by the data storage controller and in response to the request to mark the identified data as immutable, the identified data.

Example 31 includes the subject matter of any of Examples 28-30, and wherein compacting the identified data comprises compressing the identified data.

Example 32 includes the subject matter of any of Examples 28-31, and wherein compacting the identified data comprises performing a deduplication process on the identified data.

Example 33 includes the subject matter of any of Examples 28-32, and further including performing a re-encoding process on the identified data.

Example 34 includes the subject matter of any of Examples 28-33, and further including moving, by the data storage controller and in response to the request to mark the identified data as immutable, the identified data to an immutable memory region of the memory.

Example 35 includes the subject matter of any of Examples 28-34, and wherein moving the identified data to the immutable memory region comprises moving the identified data from an original memory region of the memory to a new memory region of the memory having a lower endurance or lower write-performance than the original memory region of the memory.

Example 36 includes the subject matter of any of Examples 28-35, and further including compacting, by the data storage controller and in response to the request to mark the identified data as immutable, the identified data; and moving, by the data storage controller, the compacted identified data from an original memory region of the memory to a new memory region of the memory having a lower endurance or lower write-performance than the original memory region of the memory

Example 37 includes the subject matter of any of Examples 28-36, and further including determining, by the data storage controller and after the immutable flag associated with the identified data is set, a remaining storage capacity of the memory; and updating, by the data storage controller, the host with the determined remaining storage capacity.

Example 38 includes the subject matter of any of Examples 28-37, and wherein receiving the request comprises receiving, from the host, a request that identifies a logical block address range of data stored in the memory that is to be marked as immutable.

Example 39 includes the subject matter of any of Examples 28-38, and wherein receiving the request comprises receiving, from the host, a request that identifies a data object of data stored in the memory that is to be marked as immutable.

Example 40 includes the subject matter of any of Examples 28-39, and wherein setting the immutable flag associated with the identified data comprises setting an immutable flag of a logical-to-physical table stored in a volatile memory associated with the memory.

Example 41 includes the subject matter of any of Examples 28-40, and further including receiving, by the data storage controller and from the host, a request to mark the immutable data as mutable; and resetting, by the data storage controller and in response to the request to mark the immutable data as mutable, the immutable flag associated with the immutable data, wherein the immutable flag, when reset, indicates that the associated immutable data is modifiable.

Example 42 includes the subject matter of any of Examples 28-41, and further including determining, by the data storage controller and in response to the request to mark the immutable data as mutable, whether the immutable data is compacted; determining, by the data storage controller and in response to a determination that the immutable data is compacted, whether the memory has a sufficient remaining storage capacity to store the immutable data in an un-compacted state; and uncompacting, by the data storage controller and in response to a determination that the memory has a sufficient remaining storage capacity, the compacted immutable data.

Example 43 includes the subject matter of any of Examples 28-42, and further including moving, by the data storage controller and in response to the request to mark the immutable data as mutable, the immutable data to a mutable memory region of the memory.

Example 44 includes the subject matter of any of Examples 28-43, and wherein moving the immutable data to the mutable memory region comprises moving the immutable data from an original memory region of the memory to a new memory region of the memory having a higher endurance than the original memory region of the memory.

Example 45 includes the subject matter of any of Examples 28-44, and further including unblocking, by the data storage controller, write requests to the immutable data in response to the immutable flag associated with the immutable data being reset.

Example 46 includes the subject matter of any of Examples 28-45, and further including determining, by the data storage controller and after the immutable flag associated with the immutable data is reset, a remaining storage capacity of the memory; and updating, by the data storage controller, the host with the determined remaining storage capacity.

Example 47 includes the subject matter of any of Examples 28-46, and further including receiving, by the data storage controller and from the host, a write request to write to the immutable data; converting, by the data storage controller and in response to the write request, the immutable data to mutable data; performing, by the data storage controller, the write request on the converted mutable data; and converting, by the data storage controller and in response to performance of the write request, the mutable data to immutable data.

Example 48 includes the subject matter of any of Examples 28-47, and wherein converting the immutable data to mutable data comprises resetting, in response to the write request, the immutable flag associated with the immutable data, wherein the immutable flag, when reset, indicates that the associated immutable data is modifiable.

Example 49 includes the subject matter of any of Examples 28-48, and wherein converting the immutable data to mutable data comprises uncompacting the immutable data in response to a determination that the memory has sufficient storage capacity to store the un-compacted immutable data.

Example 50 includes the subject matter of any of Examples 28-49, and wherein converting the mutable data to immutable data comprises compacting the mutable data.

Example 51 includes the subject matter of any of Examples 28-50, and wherein converting the immutable data to mutable data comprises moving the immutable data from an original memory region of the memory to a new memory region of the memory having a higher endurance or higher write performance than the original memory region of the memory.

Example 52 includes the subject matter of any of Examples 28-51, and wherein converting the mutable data to immutable data comprises moving the mutable data from the new memory region to the original memory region.

Example 53 includes the subject matter of any of Examples 28-52, and wherein converting the mutable data to immutable data comprises setting, in response to performance of the write request, the immutable flag.

Example 54 includes the subject matter of any of Examples 28-53, and further including receiving, by the data storage controller and from the host, a delete request to delete the immutable data; trimming, by the data storage controller and in response to the delete request, immutable data; and determining, by the data storage controller and after the immutable data is trimmed, a remaining storage capacity of the memory; and updating, by the data storage controller, the host with the determined remaining storage capacity.

Example 55 includes one or more computer-readable storage media comprising a plurality of instructions that, when executed, cause a data storage controller to perform the method of any of Examples 28-54.

Example 56 includes an apparatus comprising means for receiving, from a host, a request to mark data identified by the request and stored in a memory of the apparatus as immutable; and means for setting, in response to the request to mark the identified data as immutable, an immutable flag associated with the identified data to mark the identified data as immutable data, wherein the immutable flag, when set, indicates that the associated immutable data is unmodifiable.

Example 57 includes the subject matter of Example 56, and further including means for blocking write requests to the immutable data in response to the immutable flag associated with the immutable data being set.

Example 58 includes the subject matter of any of Examples 56 and 57, and wherein further comprising means for compacting, in response to the request to mark the identified data as immutable, the identified data.

Example 59 includes the subject matter of any of Examples 56-58, and wherein the means for compacting the identified data comprises means for compressing the identified data.

Example 60 includes the subject matter of any of Examples 56-59, and wherein the means for compacting the identified data comprises means for performing a deduplication process on the identified data.

Example 61 includes the subject matter of any of Examples 56-60, and further including means for performing a re-encoding process on the identified data.

Example 62 includes the subject matter of any of Examples 56-61, and further including means for moving, in response to the request to mark the identified data as immutable, the identified data to an immutable memory region of the memory.

Example 63 includes the subject matter of any of Examples 56-62, and wherein the means for moving the identified data to the immutable memory region comprises means for moving the identified data from an original memory region of the memory to a new memory region of the memory having a lower endurance or lower write-performance than the original memory region of the memory.

Example 64 includes the subject matter of any of Examples 56-63, and further including means for compacting, in response to the request to mark the identified data as immutable, the identified data; and means for moving the compacted identified data from an original memory region of the memory to a new memory region of the memory having a lower endurance or lower write-performance than the original memory region of the memory

Example 65 includes the subject matter of any of Examples 56-64, and further including means for determining, after the immutable flag associated with the identified data is set, a remaining storage capacity of the memory; and means for updating the host with the determined remaining storage capacity.

Example 66 includes the subject matter of any of Examples 56-65, and wherein the means for receiving the request comprises means for receiving, from the host, a request that identifies a logical block address range of data stored in the memory that is to be marked as immutable.

Example 67 includes the subject matter of any of Examples 56-66, and wherein the means for receiving the request comprises means for receiving, from the host, a request that identifies a data object of data stored in the memory that is to be marked as immutable.

Example 68 includes the subject matter of any of Examples 56-67, and wherein the means for setting the immutable flag associated with the identified data comprises means for setting an immutable flag of a logical-to-physical table stored in a volatile memory associated with the memory.

Example 69 includes the subject matter of any of Examples 56-68, and further including means for receiving, from the host, a request to mark the immutable data as mutable; and means for resetting, in response to the request to mark the immutable data as mutable, the immutable flag associated with the immutable data, wherein the immutable flag, when reset, indicates that the associated immutable data is modifiable.

Example 70 includes the subject matter of any of Examples 56-69, and further including means for determining, in response to the request to mark the immutable data as mutable, whether the immutable data is compacted; means for determining, in response to a determination that the immutable data is compacted, whether the memory has a sufficient remaining storage capacity to store the immutable data in an un-compacted state; and means for uncompacting, in response to a determination that the memory has a sufficient remaining storage capacity, the compacted immutable data.

Example 71 includes the subject matter of any of Examples 56-70, and further including means for moving, in response to the request to mark the immutable data as mutable, the immutable data to a mutable memory region of the memory.

Example 72 includes the subject matter of any of Examples 56-71, and wherein the means for moving the immutable data to the mutable memory region comprises means for moving the immutable data from an original memory region of the memory to a new memory region of the memory having a higher endurance than the original memory region of the memory.

Example 73 includes the subject matter of any of Examples 56-72, and further including means for unblocking write requests to the immutable data in response to the immutable flag associated with the immutable data being reset.

Example 74 includes the subject matter of any of Examples 56-73, and further including means for determining, after the immutable flag associated with the immutable data is reset, a remaining storage capacity of the memory; and means for updating the host with the determined remaining storage capacity.

Example 75 includes the subject matter of any of Examples 56-74, and further including means for receiving, from the host, a write request to write to the immutable data; means for converting, in response to the write request, the immutable data to mutable data; means for performing the write request on the converted mutable data; and means for converting, in response to performance of the write request, the mutable data to immutable data.

Example 76 includes the subject matter of any of Examples 56-75, and wherein the means for converting the immutable data to mutable data comprises means for resetting, in response to the write request, the immutable flag associated with the immutable data, wherein the immutable flag, when reset, indicates that the associated immutable data is modifiable.

Example 77 includes the subject matter of any of Examples 56-76, and wherein the means for converting the immutable data to mutable data comprises means for uncompacting the immutable data in response to a determination that the memory has sufficient storage capacity to store the un-compacted immutable data.

Example 78 includes the subject matter of any of Examples 56-77, and wherein the means for converting the mutable data to immutable data comprises means for compacting the mutable data.

Example 79 includes the subject matter of any of Examples 56-78, and wherein the means for converting the immutable data to mutable data comprises means for moving the immutable data from an original memory region of the memory to a new memory region of the memory having a higher endurance or higher write performance than the original memory region of the memory.

Example 80 includes the subject matter of any of Examples 56-79, and wherein the means for converting the mutable data to immutable data comprises means for moving the mutable data from the new memory region to the original memory region.

Example 81 includes the subject matter of any of Examples 56-80, and wherein the means for converting the mutable data to immutable data comprises means for setting, in response to performance of the write request, the immutable flag.

Example 82 includes the subject matter of any of Examples 56-81, and further including means for receiving, from the host, a delete request to delete the immutable data; means for trimming, in response to the delete request, immutable data; and means for determining, after the immutable data is trimmed, a remaining storage capacity of the memory; and means for updating the host with the determined remaining storage capacity.

1. An apparatus comprising:
a non-volatile memory to store data therein; and
a data storage controller to manage read/write access the memory, wherein the data storage controller is to:
receive, from a host, a request to mark data identified by the request and stored in the memory as immutable;
set, in response to the request to mark the identified data as immutable, an immutable flag associated with the identified data to mark the identified data as immutable data, wherein the immutable flag, when set, indicates that the associated immutable data is unmodifiable.

2. The apparatus of claim 1, wherein the data storage controller is further to compact, in response to the request to mark the identified data as immutable, the identified data.

3. The apparatus of claim 1, wherein the data storage controller is further to move, in response to the request to mark the identified data as immutable, the identified data to an immutable memory region of the memory.

4. The apparatus of claim 3, wherein to move the identified data comprises to move the identified data from an original memory region of the memory to a new memory region of the memory having a lower endurance or lower write-performance than the original memory region of the memory.

5. The apparatus of claim 1, wherein the data storage controller is further to:
compact, in response to the request to mark the identified data as immutable, the identified data; and
move the compacted identified data from an original memory region of the memory to a new memory region of the memory having a lower endurance or lower write-performance than the original memory region of the memory

6. The apparatus of claim 1, wherein the data storage controller is further to:
receive, from the host, a request to mark the immutable data as mutable; and
reset, in response to the request to mark the immutable data as mutable, the immutable flag associated with the immutable data, wherein the immutable flag, when reset, indicates that the associated immutable data is modifiable.

7. The apparatus of claim 6, wherein the data storage controller is further to:
determine, in response to the request to mark the immutable data as mutable, whether the immutable data is compacted;
determine, in response to a determination that the immutable data is compacted, whether the memory has a sufficient remaining storage capacity to store the immutable data in an un-compacted state; and
uncompact, in response to a determination that the memory has a sufficient remaining storage capacity, the compacted immutable data.

8. The apparatus of claim 6, wherein the data storage controller is further to move, in response to the request to mark the immutable data as mutable, the immutable data to a mutable memory region of the memory.

9. The apparatus of claim 1, wherein the data storage controller is further to:
receive, from the host, a write request to write to the immutable data;
convert, in response to the write request, the immutable data to mutable data;
perform the write request on the converted mutable data; and
convert, in response to performance of the write request, the mutable data to immutable data.

10. A method comprising:
receiving, from a host and by a data storage controller of an apparatus, a request to mark data identified by the request and stored in a non-volatile memory of the apparatus as immutable; and
setting, by the data storage controller and in response to the request to mark the identified data as immutable, an immutable flag associated with the identified data to mark the identified data as immutable data, wherein the immutable flag, when set, indicates that the associated immutable data is unmodifiable.

11. The method of claim 10, wherein further comprising compacting, by the data storage controller and in response to the request to mark the identified data as immutable, the identified data.

12. The method of claim 10, further comprising moving, by the data storage controller and in response to the request to mark the identified data as immutable, the identified data from an original memory region of the memory to a new memory region of the memory having a lower endurance or lower write-performance than the original memory region of the memory.

13. The method of claim 10, further comprising:
compacting, by the data storage controller and in response to the request to mark the identified data as immutable, the identified data; and
moving, by the data storage controller, the compacted identified data from an original memory region of the memory to a new memory region of the memory having a lower endurance or lower write-performance than the original memory region of the memory

14. The method of claim 10, further comprising:
receiving, by the data storage controller and from the host, a request to mark the immutable data as mutable; and
resetting, by the data storage controller and in response to the request to mark the immutable data as mutable, the immutable flag associated with the immutable data, wherein the immutable flag, when reset, indicates that the associated immutable data is modifiable.

15. The method of claim 14, further comprising:
determining, by the data storage controller and in response to the request to mark the immutable data as mutable, whether the immutable data is compacted;
determining, by the data storage controller and in response to a determination that the immutable data is compacted, whether the memory has a sufficient remaining storage capacity to store the immutable data in an un-compacted state; and
uncompacting, by the data storage controller and in response to a determination that the memory has a sufficient remaining storage capacity, the compacted immutable data.

16. The method of claim 14, further comprising moving, by the data storage controller and in response to the request to mark the immutable data as mutable, the immutable data to a mutable memory region of the memory.

17. The method of claim 10, further comprising:
receiving, by the data storage controller and from the host, a write request to write to the immutable data;
converting, by the data storage controller and in response to the write request, the immutable data to mutable data;
performing, by the data storage controller, the write request on the converted mutable data; and
converting, by the data storage controller and in response to performance of the write request, the mutable data to immutable data.

18. One or more computer-readable storage media comprising a plurality of instructions that, when executed, cause a data storage controller to:
receive, from a host, a request to mark data identified by the request and stored in the non-volatile memory as immutable;
set, in response to the request to mark the identified data as immutable, an immutable flag associated with the identified data to mark the identified data as immutable data, wherein the immutable flag, when set, indicates that the associated immutable data is unmodifiable.

19. The one or more computer-readable storage media of claim 18, wherein the plurality of instructions, when executed, further cause the data storage controller to compact, in response to the request to mark the identified data as immutable, the identified data.

20. The one or more computer-readable storage media of claim 18, wherein the plurality of instructions, when executed, further cause the data storage controller to move, in response to the request to mark the identified data as immutable, the identified data from an original memory region of the memory to a new memory region of the memory having a lower endurance or lower write-performance than the original memory region of the memory.

21. The one or more computer-readable storage media of claim 18, wherein the plurality of instructions, when executed, further cause the data storage controller to:
compact, in response to the request to mark the identified data as immutable, the identified data; and
move the compacted identified data from an original memory region of the memory to a new memory region of the memory having a lower endurance or lower write-performance than the original memory region of the memory

22. The one or more computer-readable storage media of claim 18, wherein the plurality of instructions, when executed, further cause the data storage controller to:
receive, from the host, a request to mark the immutable data as mutable; and
reset, in response to the request to mark the immutable data as mutable, the immutable flag associated with the immutable data, wherein the immutable flag, when reset, indicates that the associated immutable data is modifiable.

23. The one or more computer-readable storage media of claim 22, wherein the plurality of instructions, when executed, further cause the data storage controller to:
determine, in response to the request to mark the immutable data as mutable, whether the immutable data is compacted;
determine, in response to a determination that the immutable data is compacted, whether the memory has a sufficient remaining storage capacity to store the immutable data in an un-compacted state; and
uncompact, in response to a determination that the memory has a sufficient remaining storage capacity, the compacted immutable data.

24. The one or more computer-readable storage media of claim 22, wherein the plurality of instructions, when executed, further cause the data storage controller to move, in response to the request to mark the immutable data as mutable, the immutable data to a mutable memory region of the memory.

25. The one or more computer-readable storage media of claim 18, wherein the plurality of instructions, when executed, further cause the data storage controller to
receive, from the host, a write request to write to the immutable data;
convert, in response to the write request, the immutable data to mutable data;
perform the write request on the converted mutable data; and
convert, in response to performance of the write request, the mutable data to immutable data.
